(19) United States
(12) Patent Application Publication
(10) Pub. No.: US 2008/0149591 A1
(43) Pub. Date: Jun. 26, 2008

(54) Method and slurry for reducing corrosion on tungsten during chemical mechanical polishing

(76) Inventors: Junaid Ahmed Siddiqui, Richmond, VA (US); Rachel Dianne McConnell, Mesa, AZ (US); Ann Marie Meyers, Phoenix, AZ (US)

Correspondence Address: AIR PRODUCTS AND CHEMICALS, INC.;PATENT DEPARTMENT, 7201 HAMILTON BOULEVARD, ALLENTOWN, PA, 181951501, US

(21) Appl. No.: 11/643,307

(22) Filed: Dec. 21, 2006

(51) Int. Cl. C09K 13/00; B44C 1/22

(52) U.S. Cl. 216/38; 252/79.1

(57) ABSTRACT

A composition and associated method for the chemical mechanical planarization (CMP) of tungsten-containing substrates on semiconductor wafers are described. The composition contains an anionic fluorosurfactant, a per-type oxidizer (e.g., hydrogen peroxide), and iron. The composition and associated method are effective in affording greatly reduced levels of tungsten etching during tungsten CMP. In some embodiments, certain aspartic acid compounds are also present in the composition and are effective in affording even lower levels of tungsten etching during tungsten CMP.

### BACKGROUND OF THE INVENTION

This invention relates generally to the chemical-mechanical planarization (CMP) composition and method of using said composition in CMP, where the composition includes a compound capable of etching tungsten and at least one inhibitor of tungsten etching. The polishing composition is useful alone or in combination with other chemicals and abrasives for polishing metal layers and thin-films associated with semiconductor manufacturing where one of the layers or films is comprised of tungsten.

There are a large number of materials used in the manufacture of integrated circuits such as a semiconductor wafer. The materials generally fall into three categories—dielectric material, adhesion and/or barrier layers, and conductive layers. The use of the various substrates, e.g., dielectric material such as TEOS, PETEOS, and low-k dielectric materials; barrier/adhesion layers such as tantalum, titanium, tantalum nitride, and titanium nitride; and conductive layers such as copper, aluminum, tungsten, and noble metals is known in the industry.

This invention pertains to slurries used for tungsten CMP. Integrated circuits are interconnected through the use of well-known multilevel interconnections. Interconnection structures normally have a first layer of metallization, an interconnection layer, a second level of metallization, and typically third and subsequent levels of metallization. Interlevel dielectric materials such as silicon dioxide and sometimes low-k materials are used to electrically isolate the different levels of metallization in a silicon substrate or well. The electrical connections between different interconnection levels are made through the use of metallized vias and in particular tungsten vias. U.S. Pat. No. 4,789,648 describes a method for preparing multiple metallized layers and metallized vias in insulator films. In a similar manner, metal contacts are used to form electrical connections between interconnection levels and devices formed in a well. The metal vias and contacts are generally filled with tungsten and generally employ an adhesion layer such as titanium nitride (TiN) and/or titanium to adhere a metal layer such as a tungsten metal layer to the dielectric material.

In one semiconductor manufacturing process, metallized vias or contacts are formed by a blanket tungsten deposition followed by a CMP step. In a typical process, via holes are etched through the interlevel dielectric (ILD) to interconnection lines or to a semiconductor substrate. Next, a thin adhesion layer such as titanium nitride and/or titanium is generally formed over the ILD and is directed into the etched via hole. Then, a tungsten film is blanket deposited over the adhesion layer and into the via. The deposition is continued until the via hole is filled with tungsten. Finally, the excess tungsten is removed by chemical mechanical polishing (CMP) to form metal vias.

The associated methods of this invention entail use of the aforementioned composition (as disclosed herein) for CMP of substrates comprised of metals and dielectric materials. In a typical CMP process, the substrate is placed in direct contact with a rotating polishing pad. A carrier applies pressure against the backside of the substrate. During the polishing process, the pad and table are rotated while a downward force is maintained against the substrate back. An abrasive and chemically reactive solution, commonly referred to as a “slurry” is deposited onto the pad during polishing, where rotation and/or movement of the pad relative to the wafer brings said slurry into the space between the polishing pad and the substrate surface. The slurry initiates the polishing process by chemically reacting with the film being polished. The polishing process is facilitated by the rotational movement of the pad relative to the substrate as slurry is provided to the wafer/pad interface. Polishing is continued in this manner until the desired film on the insulator is removed.

The slurry composition is an important factor in the CMP step. Depending on the choice of the oxidizing agent, the abrasive, and other useful additives, the polishing slurry can be tailored to provide effective polishing of metal layers at desired polishing rates while minimizing surface imperfections, defects, corrosion, and erosion of oxide in areas with tungsten vias. Furthermore, the polishing slurry may be used to provide controlled polishing selectivities to other thin-film materials used in current integrated circuit technology such as titanium, titanium nitride and the like.

Typically CMP polishing slurries contain an abrasive material, such as silica or alumina, suspended in an oxidizing, aqueous medium. For example, U.S. Pat. No. 5,244,523 describes a slurry containing alumina, hydrogen peroxide, and either potassium or ammonium hydroxide that is useful in removing tungsten at predictable rates with little removal of the underlying insulating layer. U.S. Pat. No. 5,209,816 describes a slurry comprising perchloric acid, hydrogen peroxide and a solid abrasive material in an aqueous medium. U.S. Pat. No. 5,340,370 describes a tungsten polishing slurry comprising potassium ferricyanide, silica, optionally hydrogen peroxide, and potassium acetate/acetic acid to buffer the pH at approximately 3.5.

Of course, the invention described herein also encompasses the known variant where some or all of the abrasive is disposed on the face of the polishing pad.

CMP compositions are increasingly being formulated with chemical ingredients that are capable of etching tungsten in an effort to improve the rate at which tungsten vias are polished. However, in many cases the resulting CMP slurry compositions etch tungsten in a manner that solubilizes the tungsten instead of converting the surface to a soft oxidized film with improved tungsten abradeability. Due to these chemical compositions, recessing of the tungsten plug due to undesireable tungsten etching occurs. Recessed tungsten vias, where the surface of the tungsten is below that of the surrounding insulator surface, are a problem because they can cause electrical contact problems to other parts of the device. In addition, problems due to tungsten recess may be caused by the fact that the resulting nonplanarity may complicate the deposition of metal layers on subsequent levels of the device. Tungsten etching can also cause undesireable “keyholing” of tungsten vias. Keyholing is a phenomenon whereby a hole is etched into the center of a tungsten via and, thereafter, the hole migrates towards the sides of the via. Keyholing causes the same contact and filling problems as recessing.

Most of the prior art CMP slurries contain large concentrations of dissolved, ionic metallic components, most typically ferric nitrate. As a result, the polished substrates can become contaminated by the adsorption of charged species (e.g., ferric ions) into the interlayers. These species can migrate and change the electrical properties of the devices at gates and contacts and change the dielectric properties of the dielectric layers. These changes may reduce the reliability of the integrated circuits with time. Therefore, it is desirable to expose the wafer only to high purity chemicals with very low concentrations of mobile metallic ions.

U.S. Pat. No. 5,958,288 describes a slurry which has a reduced amount of dissolved metallic species in the slurry, compared to the prior art ferric nitrate-based slurries. The slurry described has hydrogen peroxide and ferric nitrate, and in its commercially useful embodiment has somewhere around 50 ppm of dissolved iron. There are several drawbacks to such a slurry, including particularly the well-known instability of aqueous hydrogen peroxide in the presence of dissolved iron and though use of such a slurry results in greatly reduced metal ion contamination as compared to polishing with ferric nitrate, in today's integrated circuits the ferric ion contamination is still so severe that special steps are typically taken to remove absorbed Fe from the surface. U.S. Pat. No. 5,958,288 describes additives which stabilize the oxidizer in the presence of the metal complex including phosphoric acid, organic acids (e.g., acetic, citric, tartaric, orthophthalic, and EDTA), tin oxides, and phosphonate compounds and other ligands which bind to the metal and reduce its reactivity toward hydrogen peroxide decomposition. These additives can be used alone or in combination to decrease the rate at which hydrogen peroxide decomposes, and may also affect tungsten polishing rates.

The slurry of U.S. Pat. No. 5,958,288 gave increased polishing rates but the problem of static etching of tungsten was observed. U.S. Pat. No. 6,083,419 and U.S. Pat. No. 6,136,711 describe adding a variety of tungsten-etch-inhibiting additives, most of which have the common characteristic of having at least one functional group selected from nitrogen containing heterocycles, sulfides, oxazolidines or mixtures of functional groups in one compound. These patents also teaches that malonic acid is a useful stabilizer for use in these slurries. This patent states that useful slurries have 0.001% to about 0.2% ferric nitrate catalyst and preferred slurries have approximately 7 to 280 ppm Fe in solution, from about 1% to about 10% hydrogen peroxide, at least one stabilizer, and from about 0.001% to about 2% and preferably from about 0.005% to about 1.0% of at least one inhibitor of tungsten etching. U.S. Pat. No. 6,083,419 and U.S. Pat. No. 6,136,711 recite a number of ranges that are not suggested by the limited examples. U.S. Pat. No. 6,083,419 recites that preferred slurries have approximately 7 to 280 ppm Fe in solution. We have found that such slurries having 7 ppm (and even up to 20 ppm) dissolved iron have no significant positive effect on tungsten removal rates over slurries using hydrogen peroxide alone, and as previously stated to be commercially useful such a slurry must have about 50 ppm of iron. In the examples, the slurries used 3.75% hydrogen peroxide and 53 ppm dissolved iron, and the rate of tungsten etching (at room temperature?) was 41 A/min. U.S. Pat. No. 6,083,419 recites that the slurry should have 0.001% to about 2% and preferably from about 0.005% to about 1.0% of at least one inhibitor of tungsten etching, though the examples had 0.04% to 0.05% of tungsten-etching inhibitors. U.S. Pat. No. 6,136,711 recites that the slurry should most preferably have 0.01% to about 0.1% of tungsten-etching inhibitors. In any case, 0.05% of a preferred inhibitor pyridazine reduced tungsten etching during polishing only 35%, from 350 A/min to 230 A/min. A value of 230 A/min is still very high. There are other problems with using slurries as described in U.S. Pat. No. 6,083,419 and U.S. Pat. No. 6,136,711. The oxidized tungsten surface is not particularly soften, so the slurry requires a very high concentration of abrasive (5% abrasive) and the preferred abrasive is fumed silica, which is a strong abrasive and use thereof results in increased defects. Also, polishing in the examples was performed at a high (5 psi) down pressure, and such pressures cause defects in today's wafers. Also, the oxidizer combination in the slurry attacks the inhibitor of tungsten etching and this patent suggests adding the inhibitor with the other ingredients immediately before use.

A major improvement over the slurries of U.S. Pat. No. 5,958,288 and U.S. Pat. No. 6,083,419 was made by using activator-coated abrasives in combination with peroxides, periodic acid, and persulfates, as is described in U.S. Pat. No. 7,029,508, U.S. Pat. No. 7,014,669, U.S. Pat. No. 7,077,880, U.S. published application 20060117667, and U.S. published application 20060180788, where the entire contents of each is incorporated herein for all permissible purposes. The use of such slurries (often described as iron-coated-silica slurries) gave polishing rates equal to that of the slurry described in U.S. Pat. No. 5,958,288 and U.S. Pat. No. 6,083,419, but the oxidizer/activator system in the activator-coated abrasive slurries is much more effective than that described in the commercial embodiments of the slurries having dissolved iron ions, resulting in: use of much less iron in the slurry and much less iron contamination of the substrates; and use of much less abrasive and preferred use of colloidal silica as opposed to fumed silica. In particular, Table 1 describes slurry and polishing characteristics giving comparable tungsten polishing rates, where slurry “A” is one which we believe exemplifies the teachings of U.S. Pat. No. 5,958,288, U.S. Pat. No. 6,083,419, and U.S. Pat. No. 6,136,711, and slurry “B” is one which we believe exemplifies the teachings of U.S. Pat. No. 7,029,508 and U.S. published application 20060117667.

TABLE 1

| | Slurry “A” | Slurry “B” |
|---|---|---|
| Hydrogen peroxide, % | ~3.75% | ~3% |
| Colloidal silica, % | ~0 | ~0.5% |
| Fumed silica, % | ~5% | ~0 |
| Dissolved iron, as ppm Fe | ~53 | ~0 |
| Abrasive-bound iron, as ppm Fe | ~0 | ~8 |
| pH | ~2.5 | ~3.5 |
| Residual Fe contamination*, (10¹⁰ atoms/cm²) | ~150 | ~10 |
| Tungsten etching inhibitor, ppm | 500 | invention |
| | pyridazine | |
| Static tungsten etching** without inhibitor at | 42 | 190 |
| room conditions, A/min | | |
| Static tungsten etching at polishing conditions** | ~350 | ~840 |
| without inhibitor, A/min | | |
| Static tungsten etching at polishing conditions** | ~230 | invention |
| with inhibitor, A/min | | |

*after post-CMP cleaning and rinsing with a dilute ammonia solution.
**during “polishing conditions” which for Slurry “B” is at 40° C. (see comparative example 3 herein)

It is clear from the information in Table 1 that the polishing slurry having iron ions bound to the abrasive allows the use of much less iron, abrasive, and even oxidizer in the slurry as compared to the slurry having dissolved ferric nitrate, and allows operation at a more moderate pH than does the slurry having dissolved ferric nitrate. Use of the polishing slurry having iron ions bound to the abrasive results in fewer defects, less contamination of the substrate, lower cost of ownership, a more environmentally benign slurry waste than does use of the slurry having dissolved ferric nitrate. Finally, the inhibitors of tungsten etching described in the aforementioned patents were not particularly effective.

What is needed in the art is an effective inhibitor of tungsten etching useful in CMP slurries having iron ions bound to the abrasive, where tungsten etching rate at polishing conditions (40° C.) can be reduced by 50% or more (relative to tungsten etching rate at 40° C. where the slurry has no inhibitor of tungsten etching) at low concentrations, e.g., 500 ppm or less, preferably 200 ppm or less of the inhibitor of tungsten etching.

### BRIEF SUMMARY OF THE INVENTION

We have surprisingly found that very low concentrations of an anionic fluorinated surfactants, preferably anionic phosphate fluorinated surfactants of which Zonyl FSJ® is a preferred example, substantially reduce tungsten etching when used in a polishing composition having a per-type oxidizer, preferably periodic acid or a peroxide oxidizer of which hydrogen peroxide is most preferred, in contact with an abrasive having small amounts of iron or copper (for example as ions or salts) attached to the surface of said abrasive wherein said iron reacts with the per-type oxidizer in a Fenton-type reaction to form hydroxyl free radicals which substantially increase the polishing (removal rate) of tungsten. The presence of said anionic fluorinated surfactants, which can be called inhibitors of tungsten etching, have only a modest effect the tungsten polishing rate (less than 20% decrease in tungsten removal rates) when compared to the polishing rate of the slurry not having said inhibitor. Preferably the amount of iron in the polishing composition is between 1 ppm and 300 ppm, more preferably between 3 ppm and 80 ppm. In said polishing composition, if the abrasive is suspended in the polishing composition to form a polishing slurry, preferably the amount of iron attached to the surface of the abrasive is between 1 ppm and 40 ppm, more preferably between 2 ppm and 24 ppm, for example between 4 ppm and 10 ppm of iron, based on the total weight of the slurry. Advantageously the amount of abrasive is less than 2% based on the weight of the slurry, preferably between 0.1% and 1%, for example between 0.25% and 0.6%, based on the total weight of the slurry. Advantageously the amount of anionic fluorinated surfactants, preferably anionic phosphate fluorinated surfactants, is less than 0.1% (1000 ppm), preferably between 10 ppm and 400 ppm, for example between 25 ppm and 100 ppm, based on the total weight of the slurry.

We have surprisingly found that very low concentrations of an N-acyl-N-hydrocarbonoxyalkyl aspartic acid compound which is a water-soluble amino acid derivative (preferably CD2128® available from King Industries, Inc., Norwalk, Conn.), reduce tungsten etching provided the pH of the polishing composition is above pH 5, preferably above pH 6. The general structure of CDX2128 from a product bulletin for this product is as follows: OH—CO—R—CO—NR₁—C(CH₂CO—OR₂)(COOR₂) where R, R₁, and R₂ are not further specifically disclosed but are presumed to be substituted or unsubstituted C1 to C6 alkanes. This compound and related useful compounds are disclosed in U.S. Pat. No. 5,275,749, entitled “N-Acyl-N-hydrocarbonoxyalkyl Aspartic Acid Esters as Corrosion Inhibitors” to King Industries, Inc. Exemplary compounds include: N-3-carboxy-1-oxypropyl-N-3-cyclohexyloxy-propyl aspartic acid diisobutyl diester or a 4-N-3-carboxy-1-oxo-propyl-N-3-isodecyloxypropyl aspartic acid diisobutyl diester. These compounds substantially reduce tungsten etching when used in a polishing composition having a per-type oxidizer, preferably periodic acid or a peroxide oxidizer of which hydrogen peroxide is most preferred, in contact with an abrasive having small amounts of iron or copper attached to the surface of said abrasive wherein said iron reacts with the per-type oxidizer in a Fenton-type reaction to form hydroxyl free radicals which substantially increase the polishing (removal rate) of tungsten, and where the pH of the slurry is above about 5.

In one aspect, the invention therefore relates to a process for polishing tungsten, where the process comprises movably contacting the face of the substrate to be polished with a polishing composition comprising a per-type oxidizer and iron irons, preferably iron ions attached to the surface of an abrasive which react with the per-type oxidizer in a Fenton-like reaction to produce hydroxyl free radicals, and an anionic fluorosurfactant, preferably an anionic phosphate fluorosurfactant.

Suitable oxidizing agents include, for example, one or more per-compounds, which comprise at least one peroxy group (—O—O—). Suitable per-compounds include, for example, peroxides (e.g., hydrogen peroxide and urea hydrogen peroxide), persulfates (e.g., monopersulfates and dipersulfates), percarbonates, perchlorates, perbromates, periodates, and acids thereof, and mixtures thereof, and the like, peroxyacids (e.g., peracetic acid, perbenzoic acid, m-chloroperbenzoic acid, salts thereof), mixtures thereof, and the like. Preferred oxidizing agents include, for hydrogen peroxide, urea-hydrogen peroxide, sodium or potassium peroxide, benzyl peroxide, di-t-butyl peroxide, peracetic acid, monopersulfuric acid, dipersulfuric acid, iodic acid, and salts thereof, and mixtures thereof. Hydrogen peroxide (H₂O₂) or periodic acid are the most preferred oxidizing agent. The per-type oxidizer is typically present in an amount between about 0.1% and 10%, for example between 0.5% and 9%, and is advantageously between 1% and 5% by weight. When used, the preferred concentration of the H₂O₂ is from about 0.5% to about 7%, for example between 0.5% and about 4.5%.

The anionic fluorosurfactant can have any of a number of structures. A typical structure can be represented by the formula A-B-D, where: “A” is a nucleophillic moiety, preferably a phosphate moiety which may have ammonium molecules associated therewith; “B” is an optional segment formed from a chain of (R—O) moieties such as ethoxy moieties; and “D” is a carbon chain having a plurality of fluorine atoms replacing hydrogen and being bonded thereto. The “B” segment can be deleted if the “D” segment provides sufficient hydrophobicity for the molecule to function as a surfactant. The above structures encompasses block copolymers. The invention also encompasses use of slurries where the anionic fluorosurfactant is polydisperse in molecular weight and/or composition.

The preferred class of anionic fluorinated surfactants useful in this invention include those having a structure as follows:

(R_{f})(R₁O)ₓZ

where: R_{f}=X(CX₂)_{y}, where X is F or any combination of H and F provided that at least a portion of the X atoms in the surfactant are F, and where y is between 1 to about 9; R₁O is independently CH₂CH₂O—, CH₂CH₂CH₂O—, or CₐH₂ₐO—, where the number of carbon atoms “a” is between 3 and 8, or any combination of the above, and where x=1 to about 25; and Z is a strong nucleophillic moiety, such as sulfonate or phosphate, preferably phosphate.

The above structures encompasses (and prefers) block copolymers, that is, a surfactant comprising blocks one or more (R₁₀)ₓ segments and/or of R_{f} segments. The invention also encompasses use of slurries where the anionic fluorosurfactant is polydisperse in molecular weight and/or composition.

Preferably at least half, more preferably at least three quarters, of the X atoms in the R_{f} segment are F. Preferably the average y in the R_{f} segment is between 3 and 6.

Preferably, R₁O is independently CH₂CH₂O—, CH₂CH₂CH₂O—, or mixture thereof, more preferably CH₂CH₂O—. A block of CH₂CH₂O— segments will form a hydrophilic section “A”, while a block of CH₂CH₂CH₂O— and/or CₐH₂ₐO— segments (where “a” is 3 or more) will form a hydrophobic section “B.” One or more of the O atoms can optionally be replaced by a N or S, but preferably more than 70%, more preferably more than 90%, and most preferably all of the bridging atoms are O.

Useful concentrations of the anionic fluorinated surfactants in the polishing slurry range from about 10 ppm to about 2000 ppm, but the preferred range is between 20 ppm and about 500 ppm, for example between about 25 and 200 ppm by weight based on the weight of the slurry.

Useful concentrations of the N-acyl-N-hydrocarbonoxyalkyl aspartic acid compound which is a water-soluble amino acid derivative range from about 10 ppm to about 500 ppm, but the preferred range is between 20 ppm and about 200 ppm, for example between about 25 and 100 ppm by weight based on the weight of the slurry.

Without being bound by theory, we believe the very high effect of very small amounts of the anionic phosphate fluorosurfactant is due to the reduced nucleophilic nature of the phosphate moiety caused by an inductive effect between a fluoride atom in a fluorocarbon segment in the surfactant and the phosphate moiety. Phosphate, in the form of phosphoric acid or polyphosphoric acid, is not desired in the slurries of this invention. Phosphoric acid can pull the Fenton's reaction activator (iron or copper) from the surface of the abrasive, resulting in loss of the benefits of having the iron attached to the silica. Also, such material may form strong bonds with the substrate, which can be difficult to remove after CMP.

It is anticipated that the anionic phosphate fluorosurfactants will also act as strong inhibitors of tungsten etching in solutions where the iron ions are in solution, for example the known prior art slurries where small amounts of ferric nitrate and larger amounts of hydrogen peroxide are present in solution. It is also anticipated that the N-acyl-N-hydrocarbonoxyalkyl aspartic acid compounds will also act as strong inhibitors of tungsten etching in solutions where the iron ions are in solution, for example the known prior art slurries where small amounts of ferric nitrate and larger amounts of hydrogen peroxide are present in solution.

The abrasive can include any suitable abrasive, e.g., fumed or colloidal silica, alumina, gamma alumina, ceria, abrasive plastic or polymeric particles, spinels, zinc oxide, hybrid organic/inorganic particle (e.g., silicone particles such as Tospearl™, Toshiba Silicone Co., Ltd., Tokyo, Japan) or mixtures thereof. The weight average abrasive particle size is between 10 nanometers and 0.5 microns, preferably between 20 nanometers and 210 nanometers.

The preferred abrasive is colloidal silica or alternatively a mixture of colloidal silica and fumed silica, which may be bimodal in size distribution. The most preferred abrasive is colloidal silica. The colloidal silica can comprise a stabilizer containing Al, B, or both on the surface thereof. For example, the colloidal silica can be borate-surface-modified colloidal silica such as is described in U.S. Pat. No. 6,743,267, or aluminum-acetate-surface-modified silica such as is described in U.S. Pat. No. 6,893,476. Not all abrasive need have activator ions such as copper ions and/or the preferred iron ions attached to the surface thereof, though some abrasive should have an activator thereon. Indeed, a preferred commercial embodiment has only 0.5% abrasive, of which only one half of this abrasive has activator ions (iron) attached to the surface thereof. Very little activator and very little abrasive are needed because the Fenton's reaction within the polishing composition generates very strong free radicals, believed to include hydroxyl free radicals, which react with tungsten surfaces to form compounds that are easily abraded from the surface. The activator ions can be attached directly to the abrasive, e.g., silica, or a boron-containing or aluminum-containing or tungsten-containing stabilizer can be bound onto the surface of the abrasive and then the activator ions can be bound to the stabilizer, as is described for example in U.S. Pat. No. 7,077,880 The abrasive is present in the slurry in a concentration of about 0.1% to 10%, typically 0.25% to 3%, preferably 0.4% to 1% of the total weight of the slurry.

### DETAILED DESCRIPTION OF THE INVENTION

Disclosed herein is an effective combination of an anionic fluorosurfactant, and particularly an anionic phosphate fluorosurfactant containing small amounts of a hydrocarbon surfactant such as Zonyl FSJ®, a per-type oxidizer which is preferably a peroxide, and abrasive material having activator ions (e.g., iron and/or copper ions, preferably iron ions) bound to the surface thereof and available to react with the hydrogen peroxide at different ratios to control the tungsten etching rate with very little effect on the removal rate of tungsten during polishing. The invention is useful with other anionic phosphate fluorosurfactants (e.g., Zonyl® FSP) so long as the nucleophillic nature of the phosphate moiety is moderated somewhat by at least one fluoride atom in the surfactant. Useful concentrations of the anionic fluorinated surfactants in the polishing slurry range from about 10 ppm to about 2000 ppm, but the preferred range is between 20 ppm and about 400 ppm, for example between about 25 and about 100 ppm by weight based on the weight of the slurry.

The anionic phosphate fluorosurfactant can have any of a number of structures. A typical structure (depicted in the acid form with hydrogens and/or ammonium not shown on the phosphate moiety) can be represented by the formula R_{f}(R₁O)ₓ(PO_{d}) where: R_{f}=X(CX₂)_{y}, where X is F or any combination of H and F provided that at least a portion of the X atoms in the surfactant are F, and where y is between 1 to about 9, for example from 3 to 7; R₁O is independently CH₂CH₂O—, CH₂CH₂CH₂O—, or CₐH₂ₐO— where the number of carbon atoms “a” is between 3 and 8, or any combination of the above, and where x=1 to about 25, preferably between 1 and 4; and PO_{d} is a phosphate moiety which may have one or more ammonium ions associated with or be bound thereto. The above structures encompasses (and prefers) block copolymers, that is, a surfactant comprising blocks one or more (R₁O)ₓ segments and/or of R_{f} segments. The invention also encompasses use of slurries where the anionic fluorosurfactant is polydisperse in molecular weight and/or composition.

Preferably at least half, more preferably at least three quarters, and most preferably all of the X atoms in the R_{f} segment are F. Preferably the average y in the R_{f} segment is between 3 and 6.

Preferably, R₁O is independently CH₂CH₂O—, CH₂CH₂CH₂O—, or mixture thereof, more preferably CH₂CH₂O—. A block of CH₂CH₂O— segments will form a hydrophilic section “A”, while a block of CH₂CH₂CH₂O— and/or CₐH₂ₐO— segments (where “a” is 3 or more) will form a hydrophobic section “B.”

A useful anionic phosphate fluorosurfactant is Zonyl FSP®, obtained from E.I. DuPont de Nemours, Wilmington, Del., which is believed to have the following formula:

R_{f}(CH₂CH₂O)ₓP(O)(ONH4)_{y}

Where
R_{f}=F(CF₂CF₂)_{z}
x=1 or 2
y=2 or 1
x+y=3
z=1 to about 7.

Another useful anionic phosphate fluorosurfactant is Zonyl FSJ®, which is an anionic phosphate fluorosurfactant of formula R_{f}(CH₂CH₂O)ₓP(O)(ONH₄)_{y} where R_{f} is a fluorinated hydrocarbon segment F(CF₂CF₂)_{z}, x=1 or 2, y=2 or 1, x+y=3, and z=1 to about 7.

Other chemicals that may be added to the CMP slurry composition include, for example, other surfactants, pH-adjusting agents, corrosion inhibitors, fluorine-containing compounds, chelating agents, nitrogen-containing compounds, and salts.

The CMP slurry composition can additionally comprise pH adjusting compounds. Any pH adjusting compounds normally used in the art can be used, though potassium hydroxide is preferred. Advantageously the pH of the slurry composition prior to adding hydrogen peroxide is between 2.3 and 7, preferably between 3 and 5, for example between 3.4 and 4.

The CMP slurry composition can additionally comprise other surfactants. If present, such other surfactants are present in the range between about 20 to 1000 ppm.

The CMP slurry composition can additionally comprise film-forming agents/corrosion inhibitors. The corrosion inhibitor may be present in the slurry in a concentration of about 10 ppm to about 4000 ppm, for example between 10 ppm to about 500 ppm of the total weight of the slurry. Exemplary corrosion inhibitors are CDX2128™ and CDX2165™, both supplied by King Industries, Inc., Norwalk, Conn. U.S. Published application 20040077295 describes these compounds as phytic acids for use in reducing copper etching in copper CMP slurries.

The CMP slurry composition can optionally comprise chelating agents. Suitable chelating agents that may be added to the slurry composition include, for example, lactic acid or dihydroxyenolic compounds including especially ascorbic acid, and mixtures thereof. The chelating agents may be present in the slurry composition in a concentration of about 0% to about 3%, typically from about 0.001% to about 0.05%, for example from about 0.02% to about 0.06% of the total weight of the slurry.

The slurry compositions of this invention are used in the chemical-mechanical planarization of substrates such as integrated circuits and semiconductors. The polishing method generally includes the steps of: A) placing a substrate surface comprising tungsten metal in contact with a polishing pad; B) delivering the slurry compositions to the space between the polishing pad and the substrate surface; and C) planarizing the substrate.

Reference will now be made in detail to the preferred embodiments of the present invention, examples of which are illustrated.

Unless otherwise specified, substrate removal rates are in angstroms per minute (“A/min”), and all percentages and parts per million (“ppm”) are by weight based on the total weight of the composition.

The following examples further illustrate details for the method and compositions of this invention. The invention, which is set forth in the foregoing disclosure, is not to be limited either in spirit or scope by these examples. Those skilled in the art will readily understand that known variations of the conditions of the following procedures can be used. Information regarding processes, terminology, and sources of materials used in the various examples is provided below.
Colloidal silica is Syton® OX-K obtained from DuPont Air Products NanoMaterials L.L.C., Tempe, Ariz., and having ˜55-80 nm particles.
Centrifuged potassium stabilized colloidal silica is DP2901M, obtained from DuPont Air Products NanoMaterials L.L.C., Tempe, Ariz., and having ˜60-75 nm particles.
A slurry containing silica and iron coated silica is as described in U.S. Pat. Nos. 7,029,508 and 7,014,669.
Inhibitor is CDX2128™, obtained from King's industries, P.O. Box 588, Science Road, Norwalk, Conn. 06582.
Zonyl® FSJ is a water-soluble, anionic surfactant system. Zonyl® FSJ is a blend of an anionic phosphate fluorosurfactant and a hydrocarbon surfactant. Due to the phosphate group, Zonyl® FSJ is most effective in applications where polyvalent cations are absent. The structure Rf(CH2CH₂O)xP(O)(ONH4)w* where Rf=F(CF2CF2)z, x=1 or 2, y=2 or 1, x+y=3, and z=1 to about 7
Zonyl FSP®, obtained from E.I. DuPont de Nemours, Wilmington, Del., is an anionic phosphate fluorosurfactant believed to have the following formula: Rf(CH₂CH₂O)ₓP(O)(ONH4)_{y} where Rf=F(CF₂CF₂)_{z}, x=1 or 2, y=2 or 1, x+y=3, and z=1 to about 7.
Polishing Pads used in examples were Politex®, and IC1000 obtained from Rodel, Inc, Phoenix, Ariz.
TEOS is Tetraethyl Orthosilicate, Si(OC₂H₅)₄, a compound commonly used in chemical vapor deposition of SiO₂ (so-called “TEOS Oxide”).
PETEOS is the dielectric silicon oxide layer formed by plasma enhanced deposition of tetraethoxy silane.

Symbols and definitions are provided below:
Å is angstrom(s), sometimes depicted as “A”, which is a unit of length; —
Å/min is a polishing rate in angstroms per minute; —
BP is back pressure, in units of psi;
CMP is chemical mechanical planarization=chemical mechanical polishing;
CS is the carrier speed;
DF is the down force, or pressure, applied during CMP, in units of psi;
min is minute(s);
ml is milliliter(s);
mV is millivolt(s);
psi is pounds per square inch;
PS is the platen rotational speed of polishing tool, in rpm (revolution(s) per minute); and
SF is the slurry flow in ml/min.

All percentages are weight percentages unless otherwise indicated, and small concentrations are typically depicted as parts per million by weight (“ppm”).

Polishing parameters and data acquisition and presentation used in the examples, unless otherwise specified, are “W RR 3 psi” which is the measured tungsten removal rate in Å/min at a DF of 3 psi; and “W. RR 6 psi” which is the measured tungsten removal rate in Å/min at a DF of 6 psi.

TEOS thickness was measured with an oxide thickness measuring instrument, Nanometrics, model, #9200, manufactured by Nanometrics Inc, 1550 Buckeye, Milpitas, Calif. 95035-7418. The tungsten were measured with a metal thickness measuring instrument, ResMap CDE, model 168, manufactured by Creative Design Engineering, Inc, 20565 Alves Dr, Cupertino, Calif., 95014. The ResMap tool is a four-point probe sheet resistance tool. Twenty-five and forty nine-point polar scans were taken with the respective tools at 3-mm edge exclusion for the TEOS film.

The CMP tool that was used is a Mirra®, manufactured by Applied Materials, 3050 Boweres Avenue, Santa Clara, Calif., 95054. A Rodel IC1000, kgroove stacked on a suba IV pad supplied by Rodel, Inc, 3804 East Watkins Street, Phoenix, Ariz., 85034 was used on platen 1 for blanket and pattern wafer studies. On Platen 3 a Politex pad, supplied by Rodel was used for the TEOS defect wafers after polishing on platen 1. The IC1000 pad was broken in by conditioning the pad for 18 min at 7 lbs downforce on the conditioner. The Politex pad was broken in by polishing twenty TEOS dummy wafers with de-ionized water. In order to qualify the tool settings and the pad break-in two Tungsten monitors and two TEOS monitors were polished with a slurry containing silica and iron coated silica as described in U.S. Pat. Nos. 7,029,508 and 7,014,669 at baseline conditions.

In blanket wafer studies, a grouping of tungsten and TEOS were polished at baseline conditions. Tungsten wafers were polished first followed by TEOS wafers. The tool baseline conditions were: table speed at 123 rpm, head speed at 120 rpm, membrane pressure at 3.0 psi, inter-tube pressure of 6.3 psi, retaining ring pressure at 7.0 psi, and slurry flow at 120 ml/min.

Defect counts were measured using a Surfscan SP1 instrument manufactured by KLA Tencore, located at 1-Technology Drive, Milipita, Calif. 95035. This instrument is a laser based wafer surface inspection system. Using this instrument, particles and surface defects on unpatterned substrates were obtained. The particle count was recorded as number of defects and size of defects.

Polishing experiments were conducted using CVD deposited Tungsten wafers and TEOS wafers. These blanket wafers were purchased from Silicon Valley Microelectronics, 1150 Campbell Ave, CA 95126. The film thickness specifications are summarized below: PETEOS: 15,000 Å on Silicon, and W: 8,000 Å CVD tungsten, 400 Å TiN, 250 Å Ti, 6300 Å Thermal Oxide on silicon.

In pattern wafer studies, J085 and W-854 wafers supplied by Wafernet, Inc. 2195 Fortune Dr. San Jose, Calif. 95131 were used. J085 wafers have 4500 Å of CVD Tungsten, Ti 150 Å, TiN 100 Å, PE TEOS 4000 Å, and SiN 1650 Å. MIT 854 have M1 Mask with W: 4500 Å CVD Tungsten, 150 Å Ti, 100 Å TiN, 4500 Å PETEOS, 1650 Å of Nitride on silicon. One pattern wafer of each type was polished at the baseline conditions using the Endpoint detection system on the Mirra polisher. The Endpoint detection system is designed to use optics to determine when the metal is cleared to the underlying Oxide layer. All pattern wafers were polished using this methodology.

Static etch rates were measured using a digital hot plate, ½-inch stir bars, 250-mL glass beakers, a scissor clamp for each coupon, a digital stop watch, a Thermometer, and ˜1×1-inch tungsten wafer coupons (unpolished). Using a ruler and diamond scribe pen, we divided a tungsten wafer into 1×1-inch coupons. We then scribed the sample number of the coupon into the back of each chip. Using the ResMap, we measured and recorded the pre-thickness of the coupons, plus three extra for back-up chips. The ResMap recipe used was “W_CVD/Static E:, which was an 8-point scan. We placed the chip carefully onto the designated wafer, which was taped in the center for repeatable measurements. The orientation of the chip was consistent when measuring post-thickness static etch rates. For each sample, we placed a stir bar into a clean beaker and filled with slurry to the 200-mL line. The sample was stirred at 400 rpm. If performing under elevated temperature, we set target temperature, and monitored temperature with a thermometer. When temperature is within two degrees of target, we turned off the heater. The hot plate slightly overshot the temperature, resulting in an “average” of the target temperature. The coupon was submerged with the tungsten side facing the stir bar, without making contact, and allowed to stay in the stirred slurry bath undisturbed for the designated time. When complete, coupons were dipped immediately into DIW, rinsed under DIW tap, and dried with CDA. Metal thickness was measured following the same procedure as for measuring pre-thicknesses, taking care to orient coupons in the same manner.

It is noted that while the measurement is described as a static etch rate of tungsten, the slurry contacting the tungsten was not static. In the static etch rate test described, there would be many low energy inpacts of abrasive against the tungsten. However, there was no polishing pad urging the abrasive against the tungsten pad as occurs during polishing. We believe the “static etch rate” test as described provides data comparable to the etch rate that would occur during brief interruptions in polishing as are sometimes experienced in the art, and during transferring the substrate to a washing unit, and the like.

### EXAMPLES

For comparative Example 1, in a 5-liter beaker, a slurry containing silica and iron coated silica as described in U.S. Pat. Nos. 7,029,508 and 7,014,669 was diluted 5:1 by adding 450 grams of CMP3700M to 2250 grams of deionized water. The mixture was allowed to stir using a magnetic stirrer for 5 minutes. Directly before performing static etch rate testing, 300 grams of 30% hydrogen peroxide was added to the sample. The components of example 1 are 2350 grams of deionized water, 450 grams of a slurry containing silica and iron coated silica as described in U.S. Pat. Nos. 7,029,508 and 7,014,669, and 200 grams of hydrogen peroxide (30% solution). The amount of iron in the slurry is about 7 ppm, with essentially all of that iron being bound to the surface of the iron-coated silica. In comparative example 2, same composition as example 1 except hydrogen peroxide concentration was 3%. In comparative example 3, same composition as example 1 except hydrogen peroxide concentration was 4.5%. In example 4, same composition as example 3 except 50 ppm of CDX-2128™ was added. In example 5, same composition as example 3 except 50 ppm of CDX-2128™ was added and the pH was adjusted to 6.5. On each of these slurries, the static etch rate of tungsten was measured at room temperature (˜17° C.) and at 40° C. The slurry compositions and tungsten static etch rates of comparative examples 1-3 and examples 4-7 are shown in Table 1.

TABLE 1

| | Com. Ex 1 | Com. Ex 2 | Com. Ex 3 | Ex 4 | Ex 5 | Ex 6 | Ex 7 |
|---|---|---|---|---|---|---|---|
| Deionized | balance | balance | balance | balance | balance | balance | balance |
| water, % | | | | | | | |
| Iron-coated | ~0.25 | ~0.25 | ~0.25 | ~0.25 | ~0.25 | ~0.25 | ~0.25 |
| silica, % | | | | | | | |
| Sodium- | ~0.25 | ~0.25 | ~0.25 | ~0.25 | ~0.25 | ~0.25 | ~0.25 |
| stabilized | | | | | | | |
| colloidal | | | | | | | |
| silica, % | | | | | | | |
| Hydrogen | 2 | 3 | 4.5 | 4.5 | 4.5 | 4.5 | 4.5 |
| peroxide, % | | | | | | | |
| CDX-2128 ™, | | | | 50 | 50 | | |
| ppm | | | | | | | |
| Zonyl FSJ ™, | | | | | | 50 | |
| ppm | | | | | | | |
| Zonyl FSN ™, | | | | | | | 50 |
| ppm | | | | | | | |
| pH | 3.7 | 3.7 | 3.7 | 3.5 | 6.5 | 3.7 | 3.8 |
| Static etch | 97 | 140 | 190 | 178 | 31 | 12 | 185 |
| rate of | | | | | | | |
| tungsten at | | | | | | | |
| ~17° C., Å/min | | | | | | | |
| Static etch | 103 | 701 | 840 | 537 | 56 | 132 | 645 |
| rate of | | | | | | | |
| tungsten at | | | | | | | |
| ~40° C., Å/min | | | | | | | |

The iron ions disposed on the surface of the iron-coated silica reacts with the hydrogen peroxide promotes rapid generation of free radicals which are believed to include hydroxyl free radicals (OH*) via a pathway similar to that of the Fenton's reaction. The rate of generation of free radicals is very temperature dependent, where the reaction becomes very rapid at temperatures above about 30° C. The temperature of 40° C. was selected as that is a typical temperature over much of a wafer during CMP. It can be seen that at room temperature the static etch rate of tungsten in a slurry having 2% H₂O₂ is about 100 Å/min. This number is high but is generally acceptable. Typically customers use between 3% and 4.5% of hydrogen peroxide when using the iron-coated silica slurry, and at room temperature the static etch rate of tungsten is 140 Å/min at 3% H₂O₂ and 190 Å/min at 4.5% H₂O₂. At 40° C., however, hydrogen peroxide concentrations above 3% result in a static etch rate of tungsten of over 700 Å/min.

In Example 4, 50 ppm of CDX-2128™ was added to the slurry, and the CDX-2128™ reduced the static etch rate of tungsten slightly at room temperature but decreased the static etch rate by about 35% at 40° C., to just over 500 Å/min. CDX-2128™ has been characterized in literature as a phytic acid, and as an amine. The polishing data suggested this compound had some tungsten-inhibiting effect. The controls and Example 4 were performed at the normal tungsten polishing slurry pH of about 3.5 to 3.7. This compound is known to be useful for copper. For prior art slurries having soluble iron ions and hydrogen peroxide, utilizing an amine and increasing the pH from ˜2.5 to ˜7 increased the static tungsten etch rate, as shown in U.S. Pat. No. 6,136,711 in Example 4. The slurries where iron ions are bound to silica allows operation at a pH greater than 5, even greater than 6, for example pH 6.5. In Example 5, the same slurry was used as in Example 4, but the pH was raised to 6.5 by addition of base. The higher pH along with the 50 ppm of CDX-2128™ almost completely shut down the static etch rate of tungsten. Polishing tungsten with a slurry at a pH above 5 would be benefited by at least 0.1% of a chelating agent, as tungsten is very insoluble at near-neutral pH values.

In example 6, an anionic (phosphate) fluorocarbon was tested. In Example 6, 50 ppm of Zonyl FSJ™ was added to the slurry, and the Zonyl FSJ™ reduced the static etch rate of tungsten to essentially zero (less than 30 Å/min) at room temperature and decreased the static etch rate by about 84% (relative to control example 3) at “polishing conditions” of 40° C., to just 132 Å/min. This is an acceptable static etch rate, especially as the static etch rate declines rapidly as the temperature is reduced, which would occur during production line interruptions, transfer of the wafer between polishing surfaces, or between the polisher and a washer, and the like.

We believe the primary active ingredient in Zonyl FSJ™, that is, the anionic phosphate fluorosurfactant, provided most of the corrosion-inhibition effect that is quantified by the static etch rate. We are uncertain whether the minor amounts of the hydrocarbon surfactant present in Zonyl FSJ™ had any effect. Without being bound by theory, we believe the reduced nucleophilic nature of the phosphate moiety on the anionic phosphate fluorosurfactant reacts with the tungsten to form a protective layer thereon. Phosphate ions are useful inhibitors.

Finally, a non-ionic fluorosurfactant was tested. We had previously discovered that at high pH such non-ionic fluorosurfactants reacted with hydrogen peroxide to form a free radical, which binds with certain materials such as carbon-doped oxide (silica) low-k materials to greatly reduce the polishing rate of such materials. As is seen in Example 8, non-ionic fluorosurfactants had no effect on the static etch rate of tungsten at room temperature and a small but insufficient effect at 40° C.

The next set of examples were performed to demonstrate what concentration range of anionic phosphate fluorosurfactant would be most useful, and what effect the anionic phosphate fluorosurfactant would have on polishing rate and microstructure topography. The polishing slurries of comparative Example 8 and Examples 9 to 12 were prepared following the same general procedures as those followed for examples 1-7. Directly before performing testing hydrogen peroxide was added to each sample. The amount of iron in the slurry is about 7 ppm, with essentially all of that iron being bound to the surface of the iron-coated silica. The compositions of the slurries of comparative example 8 and examples 9 to 12 are provided in Table 2. In comparative example 8, no anionic surfactant was added. Example 9 has the same composition as comparative example 8, except 25 ppm of the anionic phosphate fluorosurfactant Zonyl FSJ™ was added. Example 10 has the same composition as comparative example 8, except 40 ppm of the anionic phosphate fluorosurfactant Zonyl FSJ™ was added. Example 11 has the same composition as comparative example 8, except 75 ppm of the anionic phosphate fluorosurfactant Zonyl FSJ™ was added. Example 12 had a higher hydrogen peroxide concentration than example 8, 4.5% versus 3% in the control, and 25 ppm of the anionic phosphate fluorosurfactant Zonyl FSJ™ was added. On each of these slurries, the static etch rate of tungsten was measured at room temperature (˜17° C.) and at 40° C., and wafer polishing tests were performed on blanket wafers and on patterned wafers. The slurry compositions, the tungsten static etch rates, and the polishing data of comparative example 8 and examples 9 to 12 are shown in Table 2.

TABLE 2

| | Com. Ex 8 | Ex 9 | Ex 10 | Ex 11 | Ex 12 |
|---|---|---|---|---|---|
| Deionized water, % | balance | balance | balance | balance | balance |
| Iron-coated silica, % | ~0.25 | ~0.25 | ~0.25 | ~0.25 | ~0.25 |
| Sodium-stabilized | ~0.25 | ~0.25 | ~0.25 | ~0.25 | ~0.25 |
| colloidal silica, % | | | | | |
| Hydrogen peroxide, % | 3 | 3 | 3 | 3 | 3 |
| Zonyl FSJ ™, ppm | 0 | 25 | 40 | 75 | 100 |
| pH | 3.7 | 3.7 | 3.7 | 3.5 | 3.7 |
| Static etch rate of | 140 | 126 | 78 | 45 | 11 |
| tungsten at ~17° C., Å/min | | | | | |
| Static etch rate of | 701 | 430 | 165 | 158 | 130 |
| tungsten at ~40° C., Å/min | | | | | |
| W RR 6 psi | 5795 | 5742 | 5149 | 4827 | 4741 |
| Pattern wafer | Center: | NA | Center: | NA | NA |
| Damascene 854 mask, | 1705 | | 1084 | | |
| 100 micron/100 micron | Middle: | | Middle: | | |
| structure, Å | 1709 | | 1109 | | |
| | Edge: 1546 | | Edge: 1031 | | |
| Pattern wafer: | Center: 1640 | NA | Center: 607 | NA | NA |
| Damascene 854 mask, | Middle: 1567 | | Middle: 668 | | |
| line dishing | Edge: 1232 | | Edge: 590 | | |
| 2 micron/2 micron, Å | | | | | |
| Plug Recess, Å | Center: 75 | NA | Center: 25 | NA | NA |
| | Middle: 29 | | Middle: 10 | | |
| | Edge: 22 | | Edge: 22 | | |
| Erosion of Site #1, Å | Center: 38 | NA | Center: 32 | NA | NA |
| | Middle: 35 | | Middle: 9 | | |
| | Edge: 50 | | Edge: 13 | | |

At 25 ppm of Zonyl FSJ™, tungsten polishing rates were similar to those of the control. At 40 ppm of Zonyl FSJ™, however, tungsten polishing rates were down just over 10% relative to those of the control. Insofar as topography of the patterned wafers is concerned, the goal is to reduce the distance between the center and the edge of the structure. The control example 8 gave deltas (distance between the center and the edge of the structure) of: only 53 angstroms for a damascene 10000 square micron structure, 408 angstroms for a damascene 1 square micron structure, 53 microns for the plug recess, and 12 microns for the Erosion site. In contrast, example 10 having only 40 ppm of Zonyl FSJ™ gave deltas (distance between the center and the edge of the structure) of: 159 angstroms for a damascene 10000 square micron structure, only 17 angstroms for a damascene 1 square micron structure, only 3 microns for the plug recess, and 19 microns for the Erosion site. While the Erosion site data was anomalous, the data showed a strong reduction in dishing of tungsten structures on the wafer. At 100 ppm, tungsten removal rates were down almost 20% relative to the removal rate exhibited by the control. The anionic phosphate fluorosurfactant is therefore very useful in the range of between about 25 ppm and 100 ppm, and a preferred range may be between 30 ppm and 70 ppm of anionic phosphate fluorosurfactant based on the weight of the slurry.

The next examples were performed to demonstrate what concentration range of CDX2165™ would be useful. It was shown that CDX2165™ was not particularly effective at pH 3.5, so the pH of these Examples was increased to about 6.5. The polishing slurries of comparative Example 13 and Examples 14 to 16 were prepared following the same general procedures as those followed for examples 1-7. Directly before performing testing hydrogen peroxide was added to each sample. The amount of iron in the slurry is about 7 ppm, with essentially all of that iron being bound to the surface of the iron-coated silica. The slurry compositions, the tungsten static etch rates, and the polishing data of the slurries of comparative example 13 and examples 14 to 16 are provided in Table 3.

TABLE 3

| | Com. Ex 13 | Ex 14 | Ex 15 | Ex 16 |
|---|---|---|---|---|
| Deionized water, % | balance | balance | balance | balance |
| Iron-coated silica, % | ~0.25 | ~0.25 | ~0.25 | ~0.25 |
| Sodium-stabilized | ~0.25 | ~0.25 | ~0.25 | ~0.25 |
| colloidal silica, % | | | | |
| Hydrogen peroxide, % | 3 | 3 | 3 | 3 |
| CDX2165° ™, ppm | 0 | 25 | 50 | 100 |
| pH | 6.5 | 6.5 | 6.5 | 5.5 |
| Static etch rate | 140 | 31 | 31 | 23 |
| of tungsten | | | | |
| at ~17° C., Å/min | | | | |
| Static etch rate | 701 | 66 | 56 | 90 |
| of tungsten | | | | |
| at ~40° C., Å/min | | | | |
| W RR 6 psi | 5469 | 5255 | 5409 | -NA |
| Pattern wafer | Center: 1705 | Center: | NA | NA |
| Damascene | Middle: 1709 | 1428 | | |
| 854 mask, 100 micron/ | Edge: 1546 | Middle: | | |
| 100 micron line, Å | | 1477 | | |
| | | Edge: 1324 | | |
| Pattern wafer: | Center: 1640 | Center: 976 | NA | NA |
| Damascene | Middle: 1567 | Middle: | | |
| 854 mask, line dishing | Edge: 1232 | 1216 | | |
| 2 micron/2 micron, Å | | Edge: 1133 | | |
| Plug Recess, Å | Center: 75 | Center: 105 | NA | NA |
| | Middle: 29 | Middle: 57 | | |
| | Edge: 22 | Edge: 28 | | |
| Erosion of Site #1, Å | Center: 38 | Center: 50 | NA | NA |
| | Middle: 35 | Middle: 47 | | |
| | Edge: 50 | Edge: 28 | | |

At 25 ppm and at 50 ppm of CDX2165°™, tungsten polishing rates were similar to those of the control. Insofar as topography of the patterned wafers is concerned, the control example 13 gave deltas (distance between the center and the edge of the structure) of: 150 angstroms for a damascene 10000 square micron structure, 400 angstroms for a damascene 1 square micron structure, 53 microns for the plug recess, and 12 microns for the erosion site. Unlike the polishing data for the anionic phosphate fluorosurfactant, here the data was more mixed. The dishing of the 10000 square micron damascene structure and the 1 square micron damascene structure were reduced, but dishing of the plug and erosion site were not helped by the CDX2165°™. CDX2165°™ is useful, but a slurry having such a compound would preferably also have an anionic phosphate fluorosurfactant, say between 25 ppm and 100 ppm of the anionic phosphate fluorosurfactant.

The invention has been illustrated by these embodiments, but is not limited to the various examples contained herein.

1. A chemical mechanical planarization composition for use in tungsten slurries, said composition comprising: between 0.5% and 9% of a per-type oxidizer, between 1 and 300 ppm of iron, and an anionic fluorosurfactant, and said composition has a pH between 2.5 and 7.

2. The chemical mechanical planarization composition of claim 1, wherein the pH is between 2.3 and 6.5, wherein the per-type oxidizer is hydrogen peroxide, and wherein the anionic fluorosurfactant is an anionic phosphate fluorosurfactant.

3. The chemical mechanical planarization composition of claim 1, wherein the per-type oxidizer is a peroxide present in an amount between 2% and 6%, wherein the slurry contains between 3 and 80 ppm of iron, and wherein the anionic fluorosurfactant is an anionic phosphate fluorosurfactant and is present in an amount between 20 ppm and about 500 ppm.

4. The chemical mechanical planarization composition of claim 1 further comprising an abrasive, wherein at least a portion of the iron is associated with a surface of said abrasive, and wherein at least a portion of the iron associated with the surface of an abrasive reacts with the per-type oxidizer to form hydroxyl radicals.

5. The chemical mechanical planarization composition of claim 4 comprising between 1 and 40 ppm of iron, wherein the per-type oxidizer is a peroxide present in an amount between 2% and 6% and the anionic fluorosurfactant is an anionic phosphate fluorosurfactant present in an amount between about 20 ppm and about 500 ppm.

6. The chemical mechanical planarization composition of claim 4 wherein the abrasive is colloidal silica, and the composition has a pH between 2.5 and 6.5.

7. The chemical mechanical planarization composition of claim 4 wherein the anionic fluorosurfactant is an anionic phosphate fluorosurfactant and the phosphate moiety is made less nucleophillic by interactions with a fluoride in the fluorosurfactant so that the iron remains associated with a surface of said abrasive.

8. The chemical mechanical planarization composition of claim 4 wherein the anionic fluorosurfactant is an anionic phosphate fluorosurfactant present in an amount between about 25 and 200 ppm.

9. The chemical mechanical planarization composition of claim 4 wherein the anionic fluorosurfactant is an anionic phosphate fluorosurfactant present in an amount between about 25 and 100 ppm.

10. The chemical mechanical planarization composition of claim 1 further comprising a compound of formula OH—CO—R—CO—NR₁—C(CH₂CO—OR₂)(COOR₂) where R is a substituted or unsubstituted C1 to C6 alkane, R₁ is hydrogen or a substituted or unsubstituted C1 to C6 alkane, and each R₂ is independently hydrogen or a substituted or unsubstituted C1 to C6 alkane.

11. A method of chemical mechanical planarization of a substrate surface comprising tungsten, said method comprising: movably contacting a substrate having a surface which comprises tungsten with a polishing pad and a polishing composition disposed between the polishing pad and the surface, said polishing composition comprising between 0.5% and 9% of a per-type oxidizer, between 1 and 300 ppm of iron, and an anionic fluorosurfactant, and the polishing composition has a pH between 2.5 and 7.

12. The method of claim 11, wherein the pH is between 2.3 and 6.5, wherein the per-type oxidizer is hydrogen peroxide, and wherein the anionic fluorosurfactant is an anionic phosphate fluorosurfactant.

13. The method of claim 11, wherein the per-type oxidizer is a peroxide present in an amount between 2% and 6%, wherein the slurry contains between 3 and 80 ppm of iron, and wherein the anionic fluorosurfactant is an anionic phosphate fluorosurfactant and is present in an amount between 20 ppm and about 500 ppm.

14. The method of claim 11, wherein the polishing composition further comprises an abrasive, wherein at least a portion of the iron is associated with a surface of at least a portion of said abrasive, and wherein at least a portion of the iron associated with the surface of an abrasive reacts with the per-type oxidizer to form hydroxyl radicals.

15. The method of claim 14, wherein the polishing composition comprises between 1 and 40 ppm of iron, wherein the per-type oxidizer is a peroxide present in an amount between 2% and 6%, and wherein the anionic fluorosurfactant is an anionic phosphate fluorosurfactant present in an amount between about 20 ppm and about 500 ppm.

16. The method of claim 14, wherein the abrasive is colloidal silica, and the polishing composition has a pH between 2.5 and 6.5.

17. The method of claim 14, wherein the anionic fluorosurfactant is an anionic phosphate fluorosurfactant and the phosphate moiety is made less nucleophillic by interactions with a fluoride in the fluorosurfactant so that the iron remains associated with a surface of said abrasive.

18. The method of claim 14, wherein the anionic fluorosurfactant is an anionic phosphate fluorosurfactant present in an amount between about 25 and 200 ppm.

19. The method of claim 14, wherein the anionic fluorosurfactant is an anionic phosphate fluorosurfactant present in an amount between about 25 and 100 ppm.

20. The method of claim 14, wherein the abrasive is colloidal silica, the amount of iron associated with the surface of the colloidal silica is between 3 ppm and 10 ppm based on the weight of the polishing composition, wherein the anionic fluorosurfactant comprises an anionic phosphate fluorosurfactant present in an amount between about 20 ppm and about 100 ppm, and the pH is between 3 and 4.
